(19) United States
(12) Patent Application Publication
(10) Pub. No.: US 2016/0318434 A1
(43) Pub. Date: Nov. 3, 2016

(54) TRAILER DOOR LINKAGE

(71) Applicant: AIR TIP PTY LTD, Alice Springs, Northern Territory (AU)

(72) Inventor: Martyn Clarke PETRICK, Northern Territory (AU)

(73) Assignee: AIR TIP PTY LTD, Alice Springs, Northern Territory (AU)

(21) Appl. No.: 15/107,814

(22) PCT Filed: Dec. 23, 2014
(86) PCT No.: PCT/AU2014/001158

§ 371 Date: Jun. 23, 2016

(30) Foreign Application Priority Data
Dec. 24, 2013 (AU) 2013905072

(51) Int. Cl. B60P 1/267; B62D 63/08; B60P 1/16

(52) U.S. Cl. CPC B60P 1/267; B60P 1/165; B62D 63/08

(57) ABSTRACT

The present invention relates to a tipping linkage for a tub of a haul body. The tub includes a side door pivotally attached thereto and the tub is arranged for pivotal movement about a tub pivot axis (TP). The tipping linkage includes a first linkage connected to a sub-frame of the haul body and to a main linkage. The main linkage is connected to a shaft connected to the tub. A door linkage is connected to the main linkage and to a door connector. The first, main and door linkages are arranged so that when tipping of the tub about the tub pivot axis (TP) is initiated by a tipping arrangement the door is moved from a closed position towards an open position, and at least a part of a force loading on the door is transmitted to the door connector and converted to a lifting force to facilitate lifting of the tub away from the sub-frame.

The present invention also relates to tipping linkage that controls the opening of the side door of the tub of the haul body.

### CROSS REFERENCE

This application claims convention priority from Australian provisional patent application 2013905072 filed on 24 Dec. 2013. The full contents of that Australian provisional patent application are hereby incorporated by this reference.

### TECHNICAL FIELD

The present invention relates to a trailer door linkage suitable for use on a tipping trailer. Such tipping trailers are commonly used in the bulk transport industry.

### BACKGROUND OF INVENTION

The applicant's earlier international patent application PCT/AU2012/000546, published as WO 2012/155206, describes improvements to haul bodies and related apparatus. Such haul bodies include tipping trailers that include a movable sidewall or door through which payload may be dumped when the tub of the trailer is tipped. The sidewall is normally moved from the closed or travel position to the open position by at least one hydraulic actuator. The haul bodies as described in WO 2012/155206 are tipped using an air bag arrangement.

Considerably energy must be exhausted by the air bag arrangement (or other tipping linkage) to achieve full tipping of a haul body, particularly when the haul body is filled to maximum payload. The present invention seeks, in a first aspect, to preferably provide a mechanism for assisting tipping of the haul body when the sidewall or door is being opened. The present invention seeks, in a second aspect, to preferably control the rate of opening of the sidewall or door during initial tipping of the tub of the haul body.

The discussion of the background to the invention herein is included to explain the context of the invention. This is not to be taken as an admission that any of the material referred to was published, known or part of the common general knowledge as at the priority date of this application.

### SUMMARY OF INVENTION

According to a first aspect of the present invention there is provided a tipping linkage for a tub of a haul body, the tub including a side door pivotally attached thereto and the tub arranged for pivotal movement about a tub pivot axis, the tipping linkage including a first linkage connected to a sub-frame of the haul body and to a main linkage, the main linkage connected to a shaft connected to the tub, a door linkage connected to the main linkage and to a door connector, said first, main and door linkages arranged so that when tipping of the tub about the tub pivot axis is initiated by a tipping arrangement the door is moved from a closed position towards an open position, at least a part of a force loading on the door is transmitted to the door connector and converted to a lifting force to facilitate lifting of the tub away from the sub-frame.

In one embodiment, the main linkage includes a second linkage and a third linkage, the second linkage and the third linkage each connected to the shaft, the second linkage connected to the first linkage and the third linkage is connected to the door linkage.

Preferably, a break joint is established between the second and third linkages and is arranged so that when the break joint is established the second and third linkages function as a single extended linkage arranged to pivot about the shaft connected to the tub. When the break joint is broken, the second and third linkages are arranged to pivot independently of each other.

Preferably the door is pivotally attached to the haul body along a lower side of the door and about a pivot axis DP₁. The lower side of the door being located generally adjacent the sub-frame of the haul body. The tub is preferably pivotally connected to the sub-frame along a pivot axis TP.

Preferably, the first linkage is arranged for pivotal connection to the sub-frame at a connection point S. Preferably, the first linkage is pivotally connected to the second linkage at connection point A. Preferably each of the second and third linkages are arranged for pivotal connection about the shaft. Preferably the third linkage is pivotally connected to the door linkage at connection point B. The door linkage, which is also described as a “fourth linkage” is preferably pivotally connected to the door connector at connection point C.

The door connector preferably includes any means for connecting movement of the door to the door (fourth) linkage. In accordance with a preferred embodiment, the door connector is integrally attached to the door and extends in a plane substantially parallel to an end wall of the tub.

In accordance with a preferred embodiment of the invention, the horizontal distance between connection point S and pivot axis point TP is about 1136 mm. The distance between connection point C and DP₁ is about 306 mm. The first linkage has a length between centres of connection of about 642 mm, the second linkage has a length between centres of about 361 mm, the third linkage has a length between centres of about 833 mm and the fourth linkage has a length between centres of about 213 mm.

According to a second aspect of the present invention there is further provided a tipping linkage for a tub of a haul body with a side door pivotally attached thereto, the tub arranged for pivotal movement relative to a sub-frame, the tipping linkage including a first linkage connected to a sub-frame of the haul body and to a main linkage, the main linkage connected to a shaft connected to the tub, a door linkage connected to the main linkage and to a door connector, said first, main and door linkages arranged so that when tipping of the tub about the tub pivot axis is initiated by a tipping arrangement the door is moved from a closed position towards an open position.

Preferably, the main linkage includes a second linkage and a third linkage, the second linkage and the third linkage each connected to the shaft, the second linkage connected to the first linkage and the third linkage is connected to the door linkage.

The relative configuration of the first, main linkage and door linkage varies as the tipping linkage is operated resulting in the linkages adopting different angular positions with respect to each other and with respect to a sub-frame of the haul body. It will be appreciated that when the main linkage includes the second and third linkages, such linkages will also adopt different angular positions with respect to each other, the first linkage, and the door linkage as the tipping linkage is operated.

Preferably, controlled opening of the door from the closed position to the fully open position is achieved by the tipping linkage operating to vary the tub tip angle to door span angle ø ratio as the door opens and/or as the force loading on the door varies.

In accordance with an embodiment of the second aspect of the invention, the first to fourth linkages are arranged so that tipping of the tub between the angles of about 0-5° from the horizontal results in a higher rate of door opening than between the angles of about 5-10° from the horizontal.

In accordance with an embodiment where the main linkage includes the second and the third linkages, there may further be provided means for holding the second linkage and the third linkage together so that they operate as the extended main linkage. In accordance with one embodiment, the holding means is preferably a latch preferably arranged so that at a predetermined orientation of the tub, the latch is released so that the second linkage and third linkage become independent linkages.

Preferably, the latch is pivotally mounted on the end of the tub. An engagement pin is also preferably mounted on the end of the tub and positioned such that at the predetermined orientation of the tub, the latch engages with the engagement pin which thereafter results in the latch releasing the latching engagement between the second linkage and the third linkage.

Preferably, in accordance with either aspect of the invention, the first linkage is arranged to be extendable in length. In accordance with one embodiment, the first linkage includes a spring housing, a spring and an internal plunger. The main linkage is arranged for connection to the spring housing and the internal plunger has a first end arranged for connection to the sub-frame of the trailer. The first linkage is extendible by virtue of the plunger being extendible out of the spring housing and the extendible nature of the first linkage increases the permissible maximum tipping of the tub.

An embodiment of the invention may further include a return arrangement arranged to facilitate return of the tub to a travel position following pivotal movement of the tub to dump a payload. The return arrangement may adopt different forms, for example hydraulic or pneumatic actuators may be used. However, one preferred form includes an air bag arrangement and a mount. The air bag arrangement is configured so that when it is operated it will press against the mount and to drive the main linkage (or extended linkage) so as to return the tub to the travel position.

The invention also provides a method of operating a door of a tipping haul body including the steps of activating a tipping linkage in accordance with the first or second aspect of the invention.

### BRIEF DESCRIPTION OF DRAWINGS

Embodiments of the invention will now be described, by way of example only, with reference to the accompanying drawings in which:

FIG. 1 is an end view of a tipping trailer fitted with a tipping linkage according to a first embodiment of the invention;

FIG. 2 is a line diagram illustrating the links of the tipping linkage as shown generally in FIG. 1 and as connected to a tub with attached tub base that is pivotally connected to a sub-frame. The tub is shown in the travel position and with the door closed;

FIG. 3 is a view similar to FIG. 2 with the door partly open and the tub base tipped to about 5° from the horizontal;

FIG. 4 is a view similar to FIG. 2 with the door extending parallel to the floor of the tub and the tub base tipped to about 10° from the horizontal;

FIG. 5 is a view similar to FIG. 2 with the door extending parallel to the floor and the tub base tipped to about 30° from the horizontal;

FIG. 6 is a view similar to FIG. 2 but showing a locking mechanism according to a second embodiment of the invention;

FIG. 7 is a view similar to FIG. 6 with the door partly open and the tub base tipped to about 5° from the horizontal;

FIG. 8 is a view similar to FIG. 6 with the door extending parallel to the floor of the tub and the tub base tipped to about 10° from the horizontal;

FIG. 9 is a view similar to FIG. 6 with the door extending parallel to the floor and the tub base tipped to about 30° from the horizontal;

FIG. 10 is an end view of a tipping trailer with a tipping linkage in accordance with a third embodiment of the invention;

FIG. 11 is an isometric view of the main linkage of the tipping linkage shown in FIG. 10;

FIGS. 12A to 12C are schematic end views of the tipping trailer shown in FIG. 10 as the trailer tub moves from the travel position (with door closed), partial tipped position (with door open) and fully tipped position (with door open); and

FIG. 13 is an enlarged end view of the trailer shown in FIG. 10.

### DETAILED DESCRIPTION

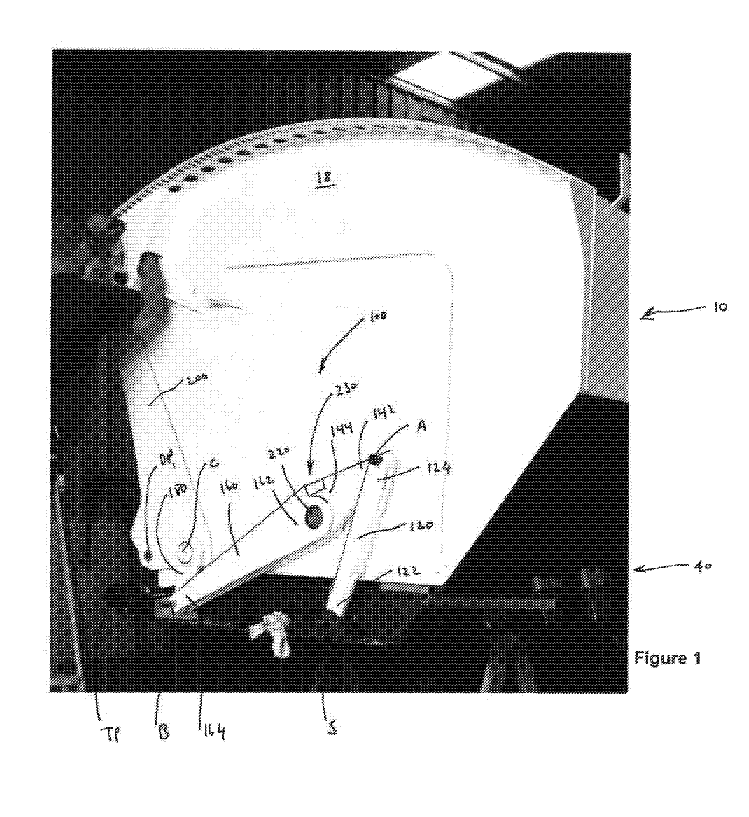

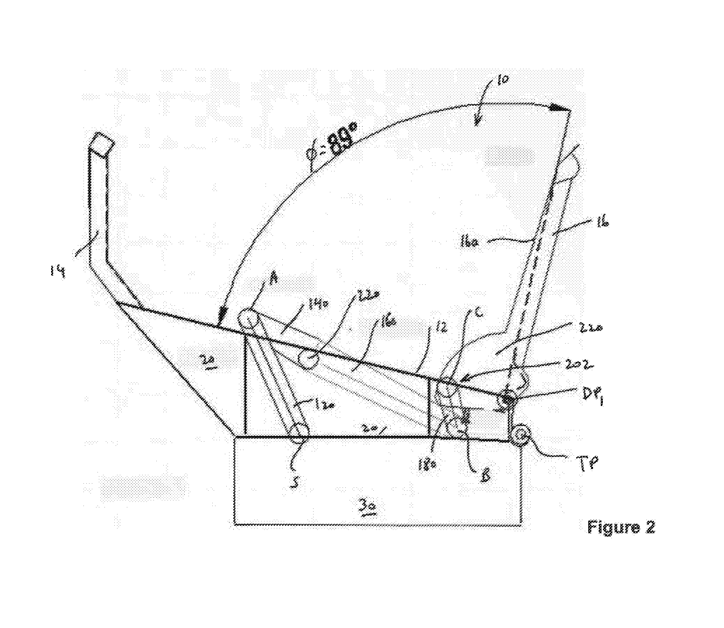

FIG. 1 shows an end view of a tub 10 of a tipping trailer fitted with a tipping linkage 100 according to an embodiment of the invention. As best seen in FIGS. 2 to 5, the tub 10 includes a floor 12, a fixed side wall 14, moveable side wall or door 16 and opposed end walls 18 (FIG. 1). The tub 10 is connected to a tub base 20.

The tub base 20 is pivotally connected to a sub-frame 30 of a trailer chassis (not shown) so that the tub 10 can be pivoted to move between a travel position and a fully tilted/tipped position in which it is arranged to discharge payload through the door 16. The tub base 20 pivots about a longitudinal tub tipping axis extending through point TP and generally parallel to the length of the tub 10. The tub 10 as shown is arranged to be tipped by an air bag arrangement 40. However, it should be understood that the present invention is not intended to be limited to use with only such tipping arrangements. For example, the present invention could be used on a tipping trailer having a tub tipped by conventional hydraulic actuators.

The tipping linkage 100 includes a first linkage 120, a second linkage 140, a third linkage 160, a door or fourth linkage 180 and a door connector 200. The door connector 200 is either attached to or formed as part of the door 16 of the tub 10 and as illustrated extends adjacent to and parallel to the plane of the end wall 18 of the tub 10.

A tipping linkage 100 is preferably provided at each end of the tub 10. However, in other embodiments, a tipping linkage 100 is only provided at one end of the tub 10.

As best shown in FIG. 1, first linkage 120 has a first end 122 arranged for pivotal connection to the sub-frame 30 at connection point S. A second end 124 of the first linkage 120 is pivotally connected at connection point A to a first end 142 of the second linkage 140. A second end 144 of the second linkage 140 is connected so as to be pivotal about a shaft 220. A first end 162 of the third linkage 160 is also pivotally connected about the shaft 220. Shaft 220 is rigidly connected to the tub base 20 and extends outwardly from the end wall 18 of the tub 10.

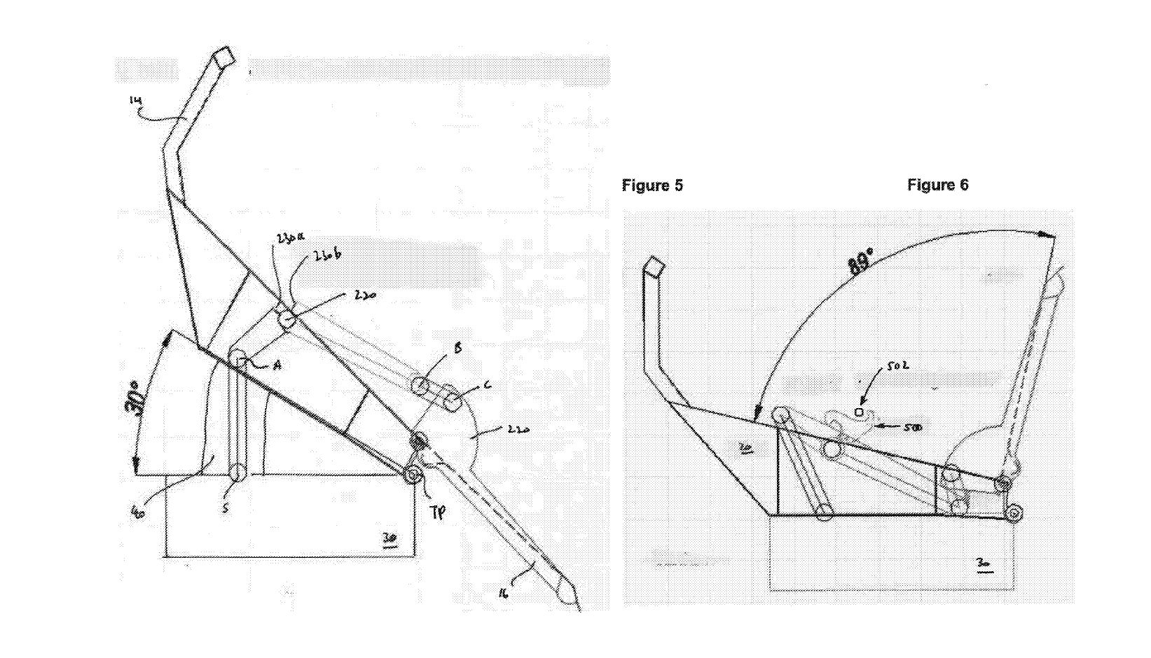

The second linkage 140 and the third linkage 160 are connectable by a break joint 230 established by joint surfaces 230a and 230b (FIG. 5). When the break joint 230 is established (i.e. when the joint surfaces 230a and 230b are in contact, FIGS. 2 to 4), the second linkage 140 and the third linkage 160 act together as a single extended linkage 140/160 (e.g. an extended or main linkage) that pivots about the shaft 220.

A second end 164 of the third linkage 160 is pivotally connected to a first end 182 of the fourth linkage 180 at connection point B. A second end 184 of the fourth linkage 180 is pivotally connected the door connector 200 at connection point C. The door connector 200 is pivotally connected about door pivot axis DP₁ to the tube base 20 at a point distal to connection C. Door pivot axis DP₁ extends generally parallel to tub tipping axis TP.

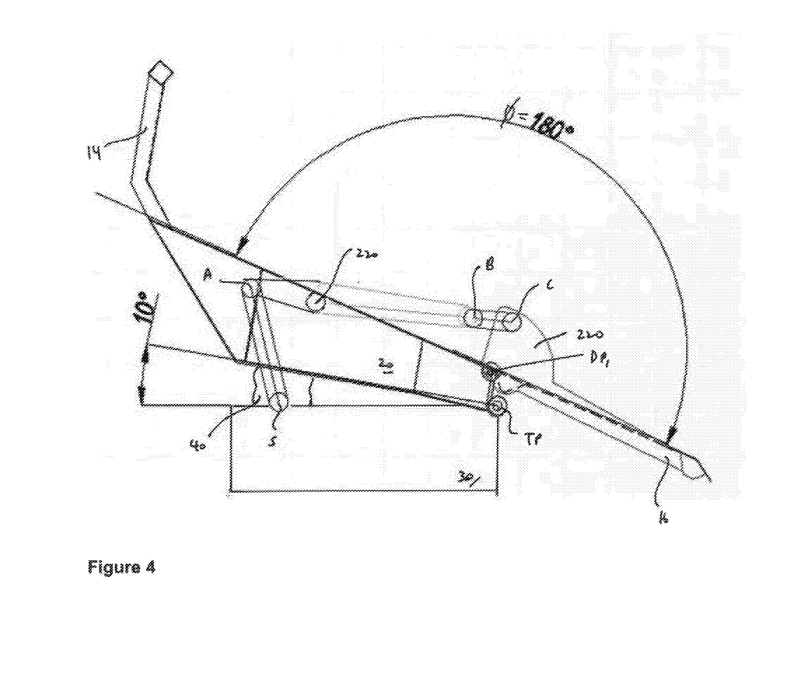

As shown in FIG. 2, the floor 12 of the tub 10 slopes downwardly in the direction from the fixed side wall 14 to the door 16. The slope of the floor 12 is approximately 13° from the horizontal. The span angle ø between the floor 14 and the inner face 16a of the door 16 is about 89° when the door 16 is in the closed or travel position. In the fully open position as shown in FIG. 4, the span angle ø between the floor 14 and the inner face 16a of the door 16 is about 180°.

It is envisaged that other floor slope angles may be adopted. For example, 10°, 11°, 12°, 14° and 15°.

The door 16 is normally held in the closed or travel position by at least one latch arrangement. Typically, each longitudinal end of the door 16 or door connection 200 includes a latch arrangement (not shown) that latches the same to keep the door 16 in the closed or travel position. If multiple latch arrangements are provided, then all need to be released before the door 16 of the tub 10 can be opened.

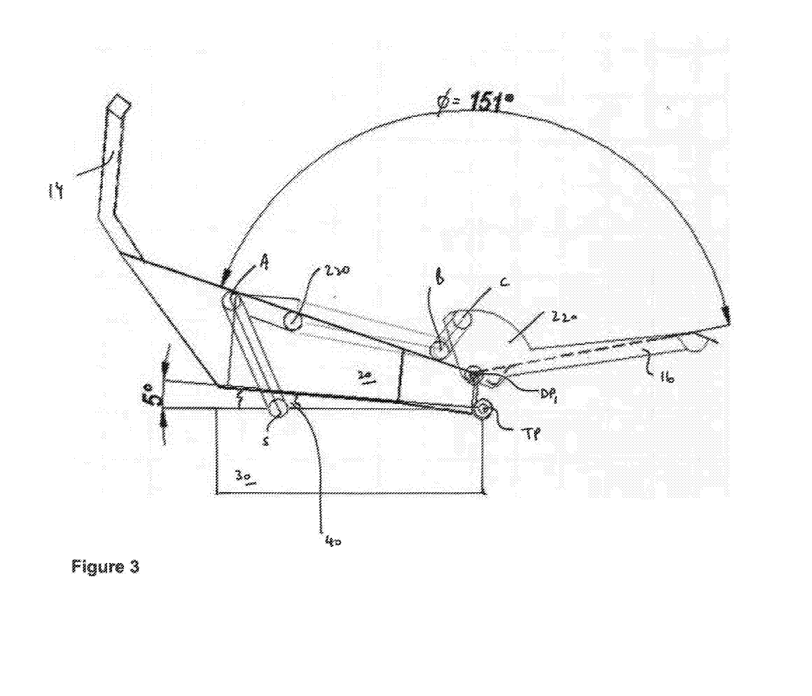

In order to dump a payload from the tub 10, the latch arrangements securing the door 16 in the closed or travel position are firstly released. Tipping of the tub 10 about tub tipping axis TP is then commenced by operation of the air bag arrangement 40. When the air bag arrangement 40 is actuated, the air bags extend applying upward pressure on the underside of the tub 10 (or tub base 20) at an area distal to the tipping axis TP. This results in the tub 10 and attached tub base 20 pivoting about the tipping axis TP and away from the sub-frame 30. As the tub 10 starts to tip, the unlatched door 16 is free to pivot about the door pivot axis DP₁ and so the door 16 will start to move away from the position shown in FIG. 2 towards the position shown in FIG. 3 under the action of gravity and any payload pressing against the door 16.

As the door 16 with attached door connector 200 pivots about DP₁, a first end 202 of the door connector 200 rotates radially about axis DP₁ (in a clockwise direction as viewed in FIG. 2) and connection point C moves upwardly from the position shown in FIG. 2 and also translated to the right (as viewed in FIG. 2) towards the position shown in FIG. 3. As a result, the first end 182 of the fourth linkage 180 lifts upwardly and pivots so that connection point C is lifted and translated to the right towards the position shown in FIG. 3. The third linkage 160 and second linkage 140 are connected together by the break joint 230 and thus pivot about the shaft 220 as a combined linkage 140/160. This results in the connection point A moving towards the position shown in FIG. 3. In FIG. 3, the door 16 span angle ø between the floor 14 and the inner face 16a of the door 16 is about 151°. The tub base 20 is pivoted from the position shown in FIG. 2 (the horizontal position) by about 5°. Accordingly, it is apparent that about a 5° tip of the tub base 20 equates to about a 62° opening of the door 16 (see FIG. 3). This is a tub tip to door opening ratio of very roughly about 1:12.

FIG. 4 shows the door 16 in the fully opened position. In this position the door 16 span angle ø between the floor 14 and the inner face 16a of the door 16 is about 180°. Also, in this position, the tub base 20 is now pivoted from the horizontal position by about 10°. Accordingly it is apparent that the further 5° tip of the tub base 20 (i.e. from the position shown in FIG. 3 to the position shown in FIG. 4) equates to about a further 29-30° opening of the door 16. This is a tub tip to door opening ratio of about 1:6 for that further tipping of the tub base 20.

The further 5° tip of the tub base 20 also has the connections A, B and C moving from the positions shown in FIG. 3 to the positions shown in FIG. 4. As shown in FIG. 4 the second linkage 140 and third linkage 160 remain connected by the break joint 230 and are still acting as the extended linkage 140/160. The extended linkage 140/160 is straight adopting its full length position.

It will be understood that the tub tip to door opening ratio is constantly changing as the span angle ø changes. At the beginning of a door opening sequence, there is minimal load on the door 16. However as the tub 10 tips, more and more of the payload within the tub 10 presses against the inner wall 16a of the door 16, making the “door” effectively heavier or increasingly loaded. The tipping linkage 100 accommodates the increased load on the door 16 by varying the ratio of tub tip to door opening. When the load on the door 16 is at a maximum, that is when the door 16 extends generally horizontally, the tub tip to door opening ratio needs to be at its lowest. It is envisaged that when the tub tip to door opening ratio is optimised through a range of door span angles ø, that the speed of the door 16 opening will be controlled, predictable and won't be subject to rapid acceleration.

Once the door 16 reaches the position shown in FIG. 4 (i.e. it cannot open any further because it will engage against the tub base 20 or other parts of the chassis on which the tube base 20 is mounted. In order to fully discharge the payload, it is necessary to be able to further tip the tub 10 and thus tipping of the tub 10 must be able to occur independently of any further opening movement of the door 16 (i.e. in a manner that does not require the span angle ø between the floor 14 and the inner face 16a of the door 16 to be further increased).

As the air bag arrangement 40 continues to operate applying upward pressure on the underside of the tub 10, the break joint 230 breaks releasing the engagement between joint surfaces 230a and 230b. Once that engagement is released, the second linkage 140 and third linkage 160 become independent linkages and therefor act independently of one another.

As the tub 10 is caused to pivot about tub pivot axis TP, connection points A, B and C will be moved from the positions shown in FIG. 4 to the positions shown in FIG. 5. In FIG. 5, the tub base 20 is pivoted to a maximum angle from the horizontal position of about 30°. As the floor 12 of the tub 10 slopes at an angle of about 13°, the total slope of the floor 12 of the tub 10 from the horizontal as shown in FIG. 5 is about 43° (i.e. 30°+13°). FIG. 5 illustrates that the second linkage 140 now operating independently of the movement of the third linkage 160.

It will be appreciated that the tipping linkage 100 is arranged so that at least some of the energy of the door 16 as it moves from the position shown in FIG. 2 to the position shown in FIG. 4 is converted into a force used to help lift the tub 10. This reduces the amount of lift force otherwise needed to be provided by the air bag arrangement 40 to pivot the connected tub 10 and tub base 20 about the pivot axis TP, from the position shown in FIG. 2 to the position shown in FIG. 4. Furthermore, instead of the door 16 opening uncontrollably under the action of gravity and any payload contained within the tipping tub 10 following release of the door latch arrangements, the tipping linkage 100 serves to control the opening speed of the door 16, by virtue of its connection thereto.

The operation of the tipping linkage 100 to assist with lifting of the tub 10 with attached tube base 12 is as follows:
1. Latch arrangements securing the door 16 in the travel or closed position are released;
2. Air bag arrangement 40 is operated to commence tipping of the tub 10 with attached tub base 12 about the tub tipping axis TP;
3. Door 16 is biased to rotate about the door pivot axis DP1 by the weight of the payload pushing against it and the weight of the door 16 under gravity.
4. As the door 16 begins to open the door connector 200 pulls on fourth linkage 180 which in turns acts to pull up third linkage 160. This action results in the second linkage 140 (now connected to the third linkage by joint connection 230 to form the extended linkage 140/160) to rotate counter clockwise (as viewed in FIGS. 2 to 4).
5. In order to rotate in this direction, extended linkage 140/160 must push first linkage 120 against the sub-frame 30 and this causes lifting of the tub 10 with attached tub base 20 away from the sub-frame 30. The lifting force resulting from movement of the linkages 180, 160, 140, 120 is applied to the tub 10 via the shaft 220 that is connected to the tub base 30.

As mentioned previously, the ratio of tip between the door 16 and the tub base 20 of an embodiment of the invention varies and is constantly changing as the tipping linkage 100 operates. In accordance with the above described embodiment, the ratio of about 11:1 is achieved when the third linkage 160 and second linkage 140 are generally parallel to one another (i.e. from about the position shown in FIG. 2 to about the position shown in FIG. 3). The ratio of about 5:1 is achieved when the third linkage 160 and second linkage are generally perpendicular to one another (i.e. from about the position shown in FIG. 3 to about the position shown in FIG. 4). Other ratios may be appropriate depending on factors such as, for example, the size of the door, size of the haul body, normal pay load, length of the first to fourth linkages etc. It will thus be appreciated that varying the tipping linkage 100 enables the rate of opening of the door 16 to be controlled.

Although not illustrated in FIGS. 1 to 5, a rubber stop may be provided generally above linkage 160 to soften the stop of the extended linkage 140/160 and to maintain a slight bend in the extended linkage (i.e. so as to prevent the extended linkage 140/160 from extending completely straight when the door 16 is fully open).

FIGS. 6 to 9 illustrate the tub 10 and tipping linkage 100 as described previously. However, in accordance with a second embodiment, a latch 500 is additionally provided. Latch 500 is pivotally connected to the end wall 18 of the tub 10 about a shaft having an axis K and operates to latch the connection between second linkage 140 and third linkage 160 during certain operational stages of the tipping linkage 100. Also extending from the end wall 18 of the tub 10 is a catch 502.

Latch 500 is arranged to force the door 16 open initially, particularly in circumstances when the tub 10 has no payload to press against the door 16 to force opening when the tub 10 is tipped. The latch 500 prevents the door 16 from being initially stuck and then falling open at a later point in time out of schedule with the arrangement described in connection with FIGS. 2 to 5.

Latch 500 also provides and extra safety measuring as it ensures that the tub 10 cannot be tipped until the door 16 is unlatched and open.

As shown in FIG. 6, when the tub 10 is in the travel position with the door 16 closed, the latch 500 operates to hold or lock the second linkage 140 and the third linkage 160 together. In other words, the latch 500 maintains the second linkage 140 and third linkage 160 as the extended linkage 140/160.

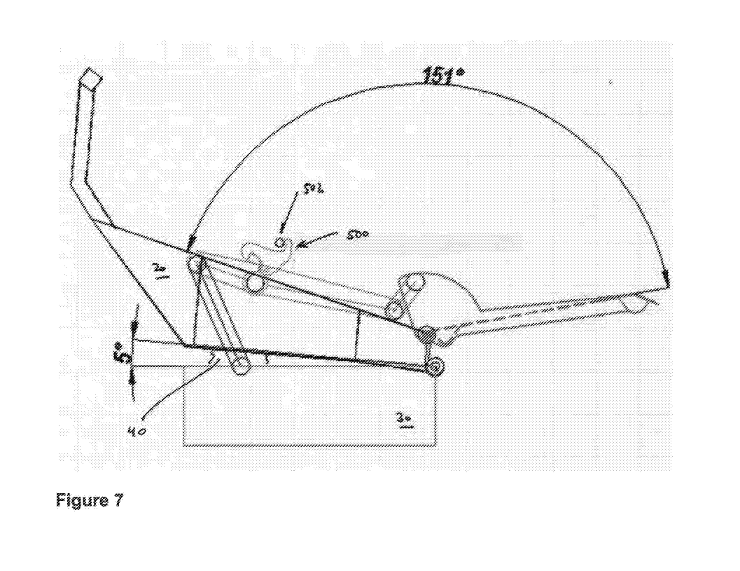

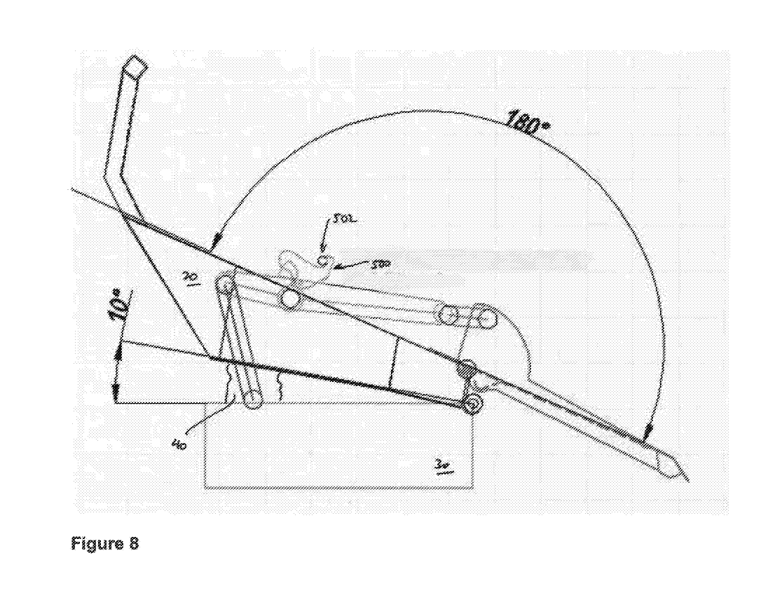

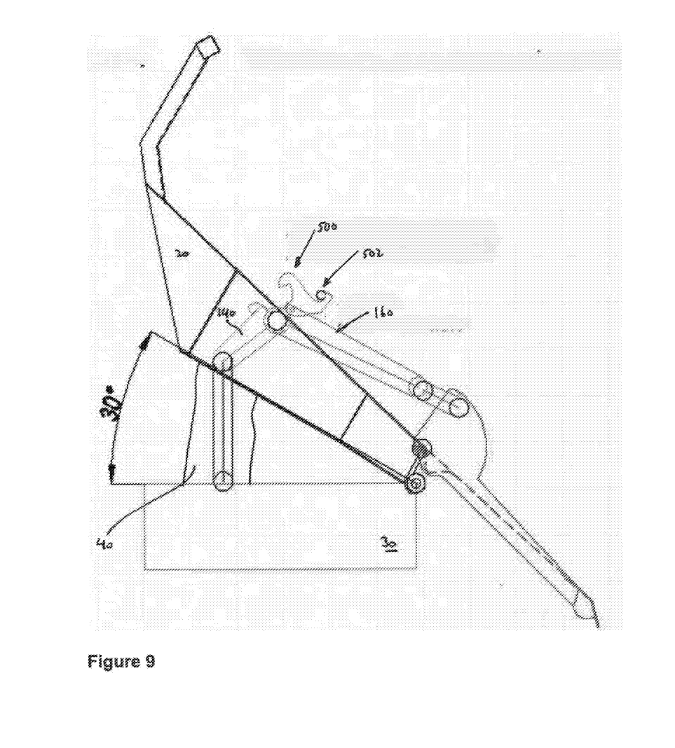

As shown in FIG. 7, in this position of the tub 10 the tipping linkage 100 has been moved to such a position that the latch 500 strikes the pin 502 on the end wall 18 of the tub 10. As then shown in FIG. 8, latch 500 then unlatches so that the second linkage 140 and third linkage 160 are no longer latched together as the extended linkage 140, 160 rotates. Accordingly, the break joint 230 is free to break so that the second linkage 140 and third linkage 160 become independent linkages 140, 160. Thus, the tub 10 is able to keep tipping upon further activation of the air bag arrangement 40 to move the tub 10 from the position shown in FIG. 8 to the position shown in FIG. 9.

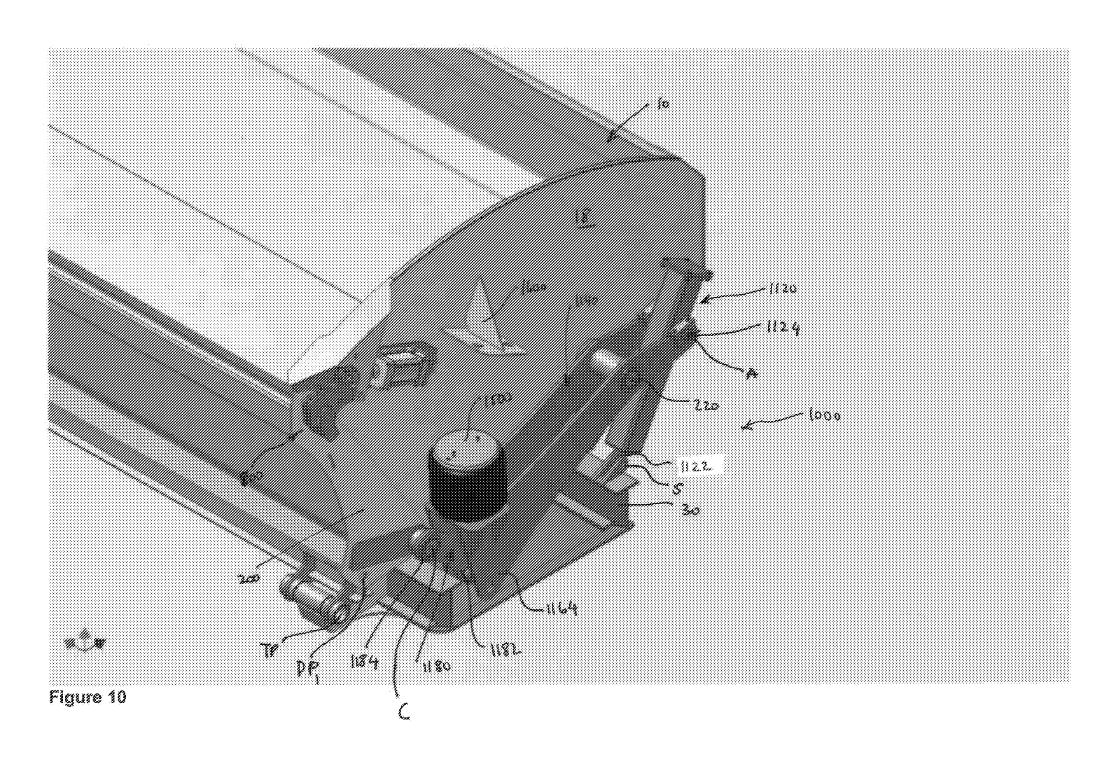

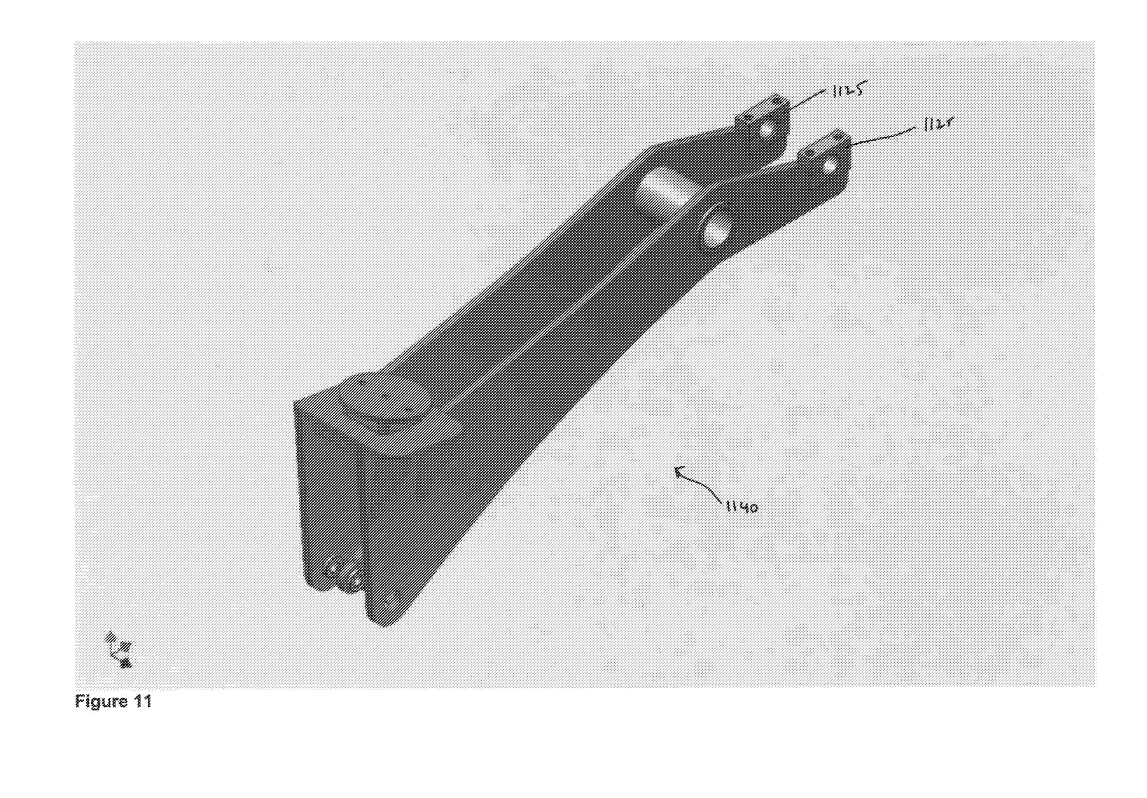

FIGS. 10 to 13 illustrate a tipping linkage 1000 according to a third embodiment of the invention. The tipping linkage 1000 includes a first linkage 1120, a main linkage 1140, a door linkage 1180 (hereafter referred to as the fourth linkage 1180) and a door connector 200. It will be noted that in accordance with this embodiment of the invention, the main linkage 1140 replicates the second and third linkages 140, 160 of the first and second embodiments of the invention when the break joint 230 is established. Hence, the main linkage 1140 is equivalent to the extended or main linkage described previously. The configuration of the main linkage 1140 is best shown in FIG. 11.

First linkage 1120 has a first end 1122 arranged for pivotal connection to the sub-frame 30 of the tipping trailer at connection point S. A second part 1124 of the first linkage 1120 is pivotally connected at connection point A to a first end 1142 of the main linkage 1140. Main linkage 1140 is pivotally connected about a shaft 220 extending from and rigidly connected to the tub base 20. A second end 1164 of the main linkage 1140 is pivotally connected to a first end 1182 of the fourth linkage 1180. A second end 1184 of the fourth linkage 1180 is pivotally connected to the door connector 200 at connection point C. The door connector 200 and attached door 16 are pivotally connected about door pivot axis DP₁ to the tub base 20 at a point distal to the connection C. Door pivot axis DP₁ extends generally parallel to the tub tipping axis TP.

An air bag arrangement 1500 is mounted on the main linkage 1140. A T-mount 1600 is mounted on the end wall 18 of the tub 10 and is arranged, as will be explained below, to engage in certain instances with the air bag arrangement 1500.

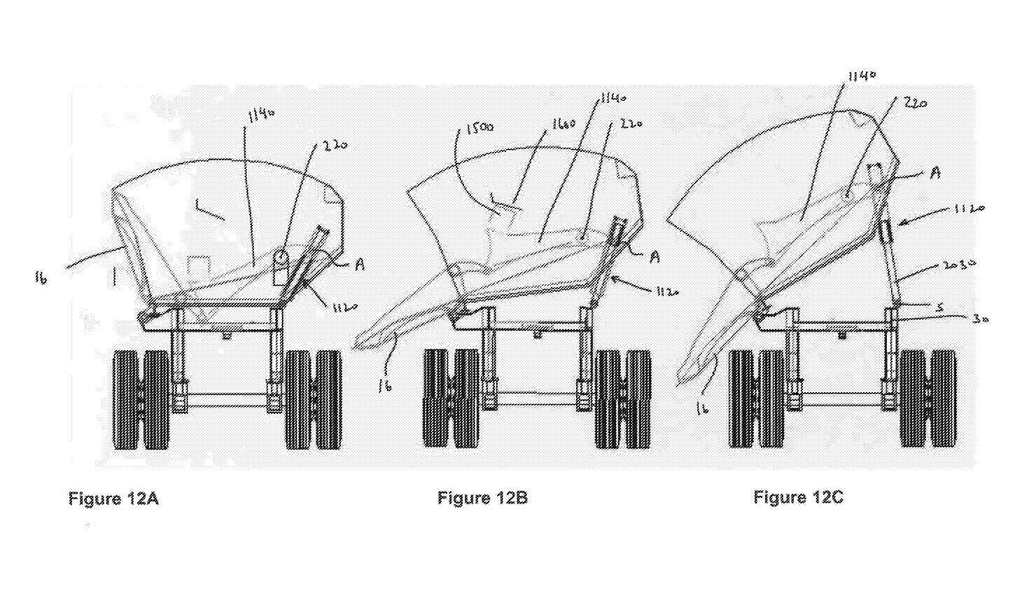

The first linkage 1120 of this third embodiment of the invention adopts a different form to the first linkage 120 described in relation to the first embodiment of the invention. More particularly, the first linkage 1120 is an extendible length linkage which is provided to enable the tub 10 to be moved to the fully tilted or fully tipped position as shown in FIG. 12C. Without such an extendible length first linkage 1120, the linkage 1000 would not be able to tip and lift to tub 10 beyond the position generally indicated in FIG. 12B.

The extendible first linkage 1120 includes a spring housing 2000, a spring 2020, an internal plunger 2030. Spring 2020 is located within the spring housing 2000 and is held between the spring housing 2000 and the internal plunger 2030.

The lower end of the internal plunger 2030 forms the first end 1122 of the first linkage 1120 and is arranged for pivotal connection to the sub-frame 30 of the tipping trailer at connection point S.

The second part 1124 of the first linkage 1120 includes a pair of stub axles 1124 axles extending either side of the spring housing 2000. A bearing block or low friction nylon bush 1125 connected to the main linkage 1140 enables the first end 1142 of the main linkage 1140 to be connected for rotation to the stub axles 1124.

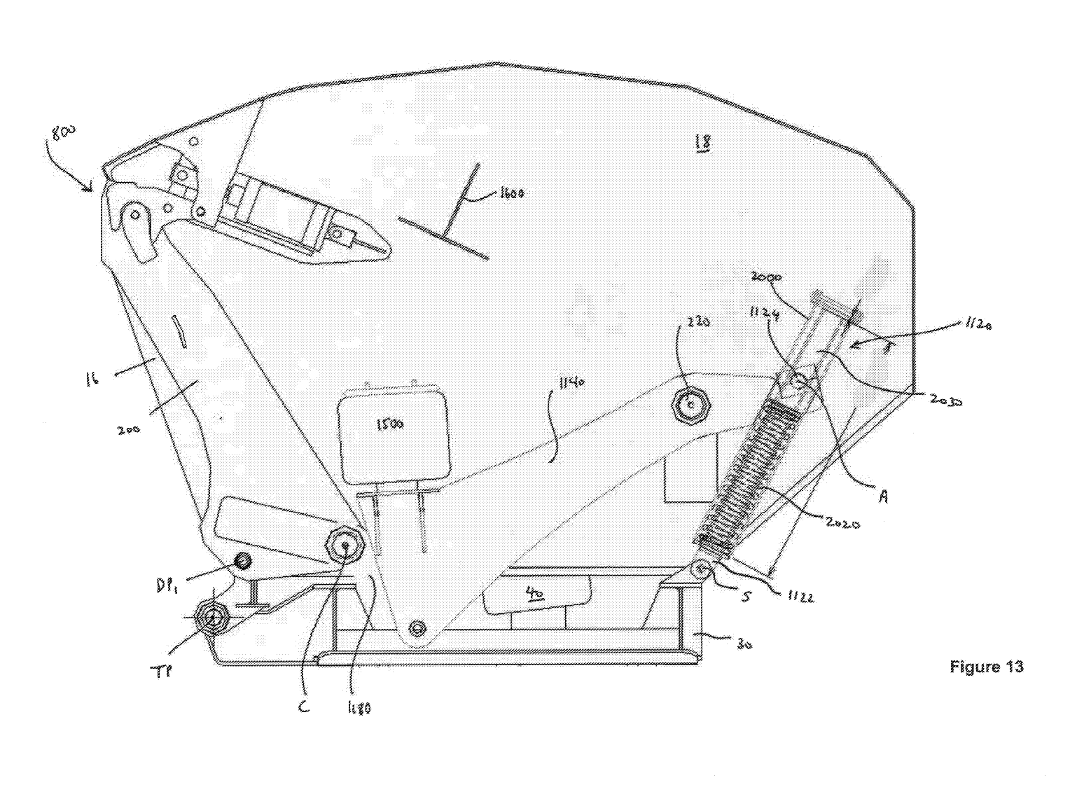

As per earlier described embodiments of the invention, the door 16 of the tub 10 of the tipping trailer is normally held in the closed or travel position by at least one latch arrangement. FIGS. 10 and 13 clearly depict one such latch arrangement 800.

In order to dump a payload from the tub 10, the latch arrangement 800 securing the door 16 in the closed or travel position is firstly released. Tipping of the tub 10 about tipping axis TP is then commenced by operation of the tipping arrangement, which as illustrated includes an air bag arrangement 40. When the air bag arrangement 40 is actuated, the air bags extend applying upward pressure on the underside of the tub 10 and/or the underside of the tub base 20 at an area distal to the tipping axis TP. This results in the tub 10 and attached tub base 20 pivoting about the tipping axis TP and away from the sub-frame 30. As the tub 10 starts to tip, the unlatched door 16 will start to move away from the closed position (FIG. 12A) and towards the fully open position (FIG. 12B) under the action of gravity and any payload pressing against the inner face 16a of the door 16. Door 16 pivots about the door pivot axis DP₁.

As the door 16 begins to open and the tub 10 is lifted, the door connector 200 pulls on fourth linkage 1180 which in turns acts to pull up and rotate the main linkage 1140. The main linkage 1140 rotates clockwise (as viewed in FIGS. 12 A to 13) about shaft 220 and lifts upwardly away from the tub base 30 until it reaches the position shown in FIG. 12B. The first linkage 1120 is also moved from the position shown in FIG. 12A to the position shown in FIG. 12B. In this position, the door 16 is fully open.

As the main linkage 1140 rotates between the position shown in FIG. 12A and the position shown in FIG. 12B, the first end 1142 of the main linkage 1140 loads downwardly at A (i.e. downward load is applied to the stub axles 1124). This downward loading forces the spring housing 2000 downwardly so that the first linkage 1120 is held at minimum length. Further, the downward loading applied by the main linkage 1140 to the first linkage 1120 results in an upward lift force being applied through the shaft 220 to lift the tub 10. This is because, in order to rotate, main linkage 1140 must push the first linkage 1120 against the sub-frame 30 and this causes lifting of the tub 10 with attached tub base 20 away from the sub-frame 30. The lifting force resulting from movement of the linkages 1180, 1140, 1120 is applied to the tub 10 via the shaft 220 that is connected to the tub base 30.

Main linkage 1140 pivots about shaft 220 until the air bag arrangement 1500 mounted on the main linkage 1140 strikes the T-mount 1600. At this point, further movement of the tub 10 from the position shown in FIG. 12B to that shown in FIG. 12C is achieved by continued inflation of the air bag arrangement 40 and extension of the first linkage 1120 from the minimum length shown in FIGS. 12A and 12B to the maximum length shown in FIG. 12C. It should be noted that for clarity reasons, the air bag arrangement 40 is not shown in FIGS. 12A to 12C.

After the tub 10 reaches the position shown in FIG. 12B, the first linkage 1120 extends in length initially passively as the tub 10 is further tipped about the tipping axis TP by the air bag arrangement 40. This passive further extension is preferably about ⅓ of the exposed stroke of the internal plunger 2030. As the tub 10 continues to tip under the action of the upward lift provided by the air bag arrangement 40, the spring 2020 is compressed within the spring housing 2000. At the later part of the tip of the tub 10, the rate of tub tip can speed up. Spring 2020 acts to reduce the tub tip speed and also any abrupt stopping of the tub tip. The retardation effect of the spring 2020 increases as the spring 2020 is compressed effectively softening the bin's movement. Once the tub 10 reaches the position shown in FIG. 12C with the internal plunger 2030 exposed to its maximum, tub tipping is complete. This is because the first linkage 1120 has reached its maximum length and thus the distance between connection point S and point A has reached its maximum.

With the payload dumped from the tub 10, air from within the air bag arrangement 40 is released so as to lower the tub 10. The compressed spring 2020 within the spring housing 2000 which is no longer subject to load via the lift force of the air bag arrangement 40, drives the lowering of the tub 10. The expanding spring 2020 works to drive the tub 10 downwardly helping to drive air out of the air bag arrangement 40, which in turn causes lowering of the tub 10. The tub 10 moves downwardly towards the sub-frame 30 in this manner until the first linkage 1120 returns to its minimum length (FIG. 12B). However, this action does not return the tub 10 back to its normal travel position, in contact with the sub-frame 30. The final return positioning of the tub 10 and closure of the door 16 is achieved by inflating the air bag arrangement 1500 so that is pushes against the T-mount 1600. This causes the main linkage 1140 to rotate in an anti-clockwise direction about the shaft 220, lowering the tub 10 to its normal travel position and also closing the door 16 (FIG. 12A).

The compressed spring 2020 within the spring housing 2000 is effective to drive lowering of the tub 10 about ⅓ of the way back from the fully tipped position. Continued lowering of the tub 10 is achieved as air is released from the air bag arrangement 40 and also by operation of the air bag arrangement 1500. The air bag arrangement 1500 is expanded, for example, up to three times its closed length, to return the tub 10 to its normal travel position.

As per the first and second embodiments of the invention, the ratio of tip between the door 16 and the tub base 20 of the third embodiment of the invention varies and is constantly changing as the tipping linkage 1000 operates.

Embodiments of the invention are advantageous because tipping of the haul body is assisted by the action of the door opening. Further, door opening is controlled preventing damage to the door and any injury risk due to a rapid door opening event.

The embodiments have been described by way of example only and modifications within the spirit and scope of the invention are envisaged.

1. A tipping linkage for a tub of a haul body, the tub including a side door pivotally attached thereto and the tub arranged for pivotal movement about a tub pivot axis, the tipping linkage including a first linkage connected to a sub-frame of the haul body and to a main linkage, the main linkage connected to a shaft connected to the tub, a door linkage connected to the main linkage and to a door connector, said first, main and door linkages arranged so that when tipping of the tub about the tub pivot axis is initiated by a tipping arrangement the door is moved from a closed position towards an open position, at least a part of a force loading on the door is transmitted to the door connector and converted to a lifting force to facilitate lifting of the tub away from the sub-frame.

2. A tipping linkage according to claim 1 wherein the main linkage includes a second linkage and a third linkage, the second linkage and the third linkage each connected to the shaft, the second linkage connected to the first linkage and the third linkage is connected to the door linkage.

3. A tipping linkage according to claim 2 wherein a break joint is established between the second and third linkages and is arranged so that when the break joint is established the second and third linkages function as a single extended linkage arranged to pivot about the shaft connected to the tub.

4. A tipping linkage according to claim 3 wherein when the break joint is broken, the second and third linkages are arranged to pivot independently of each other about the shaft.

5. A tipping linkage according to claim 1 wherein the door connector is formed as part of the door or is integrally attached to the door and is arranged to extend in a plane substantially parallel to the plane of an end wall of the tub.

6. A tippling linkage according to claim 1 wherein the tub further includes a tub base and the shaft is secured to the tub base.

7. A tipping linkage for a tub of a haul body with a side door pivotally attached thereto, the tub arranged for pivotal movement relative to a sub-frame, the tipping linkage including a first linkage connected to a sub-frame of the haul body and to a main linkage, the main linkage connected to a shaft connected to the tub, a door linkage connected to the main linkage and to a door connector, said first, main and door linkages arranged so that when tipping of the tub about the tub pivot axis is initiated by a tipping arrangement the door is moved from a closed position towards an open position.

8. A tipping linkage according to claim 7 wherein the main linkage includes a second linkage and a third linkage, the second linkage and the third linkage each connected to the shaft, the second linkage connected to the first linkage and the third linkage is connected to the door linkage

9. A tipping linkage according to claim 7 wherein the relative configuration of the first, main linkage and door linkage varies as a span angle ø between a floor of the tub and an inner side of the door varies.

10. A tipping linkage according to claim 7 wherein the first, main and door linkages are arranged so that tipping of the tub between the angles of about 0-5° from the horizontal results in a higher rate of door opening than between the angles of about 5-10° from the horizontal.

11. A tippling linkage according to claim 7 configured so that pivoting of the tub between about 0 and about 5° from the horizontal results in increasing a span angle of the door from about 89 to about 151°.

12. A tipping linkage according to claim 11 further configured so that pivoting of the tub from about 5° to 10° from the horizontal results in increasing the span angle of the door from about 151° to about 180°.

13. A tipping linkage according to claim 1 wherein the tub has a floor that slopes downwardly from a fixed sidewall to the door and wherein the angle of the slope is about 13°.

14. A tipping linkage according to claim 2 further including means for holding the second linkage and the third linkage together so that they operate together as the main linkage.

15. A tipping linkage according to claim 14 wherein the holding means is a latch arranged so that at a predetermined orientation of the tub, the latch is released so that the second linkage and third linkage become independent linkages.

16. A tipping linkage according to claim 15 wherein the latch is pivotally mounted on the end of the tub.

17. A tipping linkage according to claim 15 further including an engagement pin mounted on the end of the tub and positioned such that at the predetermined orientation of the tub, the latch engages with the engagement pin which thereafter results in the latch releasing the engagement between the second linkage and the third linkage.

18. A tipping linkage according to claim 1 wherein the first linkage is arranged to be extendable in length.

19. A tipping linkage according to claim 18 wherein the first linkage includes a spring housing, a spring and an internal plunger.

20. A tippling linkage according to claim 19 configured so that the spring is arranged to assist in lowering of the tub from a fully tipped position to a lowered position when the tipping arrangement is deactivated.

21. A tipping linkage according to claim 20 wherein the fully tipped position of the tub is achieved when the first linkage is at maximum extended length.

22. A tipping linkage according to claim 1 further including a return arrangement arranged to facilitate return of the tub to a travel position following pivotal movement of the tub to dump a payload.

23. A tipping linkage according to claim 22 wherein the return arrangement includes an air bag arrangement and a mount, and wherein the air bag arrangement is configured when operated to press against the mount and to drive the main linkage so as to return the tub to the travel position.

24. A haul body tub fitted with a tipping linkage according to claim 1.

25. A tipping haul body including a tipping linkage according to claim 1.

26. A method of operating a door of a tipping haul body including the steps of activating a tipping linkage in accordance with claim 1.
